(19) United States
(12) Patent Application Publication
(10) Pub. No.: US 2019/0020081 A1
(43) Pub. Date: Jan. 17, 2019

(54) VEHICLE BATTERY THERMOELECTRIC MODULE WITH SIMPLIFIED ASSEMBLY

(71) Applicant: Gentherm Incorporated, Northville, MI (US)

(72) Inventor: Rüdiger Spillner, Augsburg (DE)

(21) Appl. No.: 16/069,558

(22) PCT Filed: Jan. 25, 2017
(86) PCT No.: PCT/US2017/014919

§ 371 Date: Jul. 12, 2018

Related U.S. Application Data
(60) Provisional application No. 62/287,569, filed on Jan. 27, 2016.

(51) Int. Cl. H01M 10/6572; H01M 10/6554; H01M 10/04; H01M 10/613; H01M 10/625; H01M 10/658; H01M 10/667

(52) U.S. Cl. CPC H01M 10/6572; H01M 10/6554; H01M 10/0481; B60L 11/1874; H01M 10/625; H01M 10/658; H01M 10/667; H01M 10/613

(57) ABSTRACT

A cooling system for thermally conditioning a component is provided. The cooling system includes a battery providing a first side and a cold plate assembly providing a second side. A clamping support is provided, and a thermoelectric device is positioned between the first and second sides. A clamping structure is secured to the clamping support and cooperates with the battery to generate a clamping load on the thermoelectric device through the battery and with the first and second sides.

### CROSS-REFERENCE TO RELATED APPLICATIONS

This application claims priority to U.S. Provisional Application No. 62/287,569, which was filed on Jan. 27, 2016 and is incorporated herein by reference.

### BACKGROUND

This disclosure relates to a thermoelectric module used to cool a vehicle component, such as a battery. In particular, the disclosure relates to a simplified arrangement for clamping the thermoelectric module to improve heat transfer efficiency.

Lithium ion batteries are used in passenger and other types of vehicles to provide power to electric motors that provide propulsion to the vehicle. Such batteries can generate a significant amount of heat such that the battery must be cooled to prevent performance degradation.

One type of vehicle battery cooling arrangement that has been proposed that includes a thermoelectric module arranged beneath the battery and adjacent to a cold plate assembly. The thermoelectric module includes thermoelectric devices that operate based upon the Peltier effect to provide cooling adjacent to the battery. Heat transferred through the thermoelectric device is rejected to the cold plate assembly, which may have a cooling fluid circulated therethrough and sent to a heat exchanger.

It is desirable to design the thermoelectric module so as to efficiently transfer heat through some components within the thermoelectric module while insulating other components within the thermoelectric module.

### SUMMARY

In one exemplary embodiment, a cooling system for thermally conditioning a component is provided. The cooling system includes a battery providing a first side and a cold plate assembly providing a second side. A clamping support is provided, and a thermoelectric device is positioned between the first and second sides. A clamping structure is secured to the clamping support and cooperates with the battery to generate a clamping load on the thermoelectric device through the battery and with the first and second sides.

In a further embodiment of any of the above, the clamping support includes the cold plate assembly and a DC/DC converter. The clamping is structure secured to at least one of the cold plate assembly and the DC/DC converter.

In a further embodiment of any of the above, the DC/DC converter is mounted to the cold plate assembly.

In a further embodiment of any of the above, a thermal foil is arranged between and in engagement with the cold plate assembly and the DC/DC converter.

In a further embodiment of any of the above, the clamping load provides thermal communication with the thermoelectric device and the DC/DC converter and the cold plate assembly.

In a further embodiment of any of the above, fasteners secure a housing of the DC/DC converter to the cold plate assembly.

In a further embodiment of any of the above, the clamping structure is secured to the clamping support by at least one fastener.

In a further embodiment of any of the above, a heat spreader is arranged between the thermoelectric device and the battery.

In a further embodiment of any of the above, a thermal foil is arranged between and engagement with the thermoelectric device and the heat spreader.

In a further embodiment of any of the above, a thermal foil is arranged between and in engagement with the thermoelectric device and the cold plate assembly.

In a further embodiment of any of the above, the clamping load provides thermal communication with the thermoelectric device and the battery and the cold plate assembly.

In a further embodiment of any of the above, the battery includes a housing that comprises fasteners secured to a portion of the housing.

In a further embodiment of any of the above, the fasteners are threaded into the cold plate assembly.

In a further embodiment of any of the above, the cooling system includes an insulator plate. The thermoelectric device is arranged within the insulator plate that is positioned between the clamping support and the battery. The fasteners extend through the insulator plate.

In a further embodiment of any of the above, a thermal insulator is provided between the battery and the clamping structure and between the clamping structure and the clamping support.

### BRIEF DESCRIPTION OF THE DRAWINGS

The disclosure can be further understood by reference to the following detailed description when considered in connection with the accompanying drawings wherein:

FIG. 1 is a highly schematic view of a vehicle with a vehicle system temperature regulated by a cooling system.

FIG. 2 is a perspective view of the thermoelectric module assembly, a cold plate assembly and a heat spreader arranged relative to a battery to provide a battery thermal management module.

FIG. 2A is an enlarged cross-sectional view of a clamping support that includes a cold plate assembly and a DC/DC converter.

FIG. 3 is an exploded cross-sectional view of one example battery thermal management module.

FIG. 4 is a cross-sectional view of another example battery thermal management module.

FIG. 4A is a cross-sectional view of a battery enclosure secured to a clamping support.

FIGS. 5 and 5A illustrate a portion of the enclosure but with a thermal isolator and similar to the arrangement of FIGS. 4 and 4A respectively.

FIG. 6 is a cross-sectional view of the battery thermal management module shown in FIG. 3 and taken along line 6-6 in FIG. 2 in which the thermoelectric module assembly and heat spreader clamped between the battery and the cold plate assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

The disclosed cooling system provides a clamping arrangement in which the battery and the cold plate assembly and/or the DC converter are used to apply the clamping load about the thermoelectric device, which ensures desired heat transfer with respect the thermoelectric device. Such a clamping arrangement can simplify the overall cooling system by eliminating the use of plates and fasteners typically arranged between the battery and cold plate assembly that are conventionally used to provide the clamping load.

A vehicle 10 is schematically illustrated in FIG. 1. The vehicle 10 includes a vehicle system 12 that either needs to be heated or cooled. In one example, the vehicle system 12 includes a battery 14, such as a lithium ion battery used for vehicle propulsion that generates a significant amount of heat. Such a battery must be cooled during operation otherwise the battery efficiency and/or integrity may degrade.

A cooling system 18 is arranged between the battery 14 and a DC/DC converter 16 in a stack to remove heat from the battery 14 thus cooling the vehicle system 12. The DC/DC converter 16 provides an electrical interface between the battery 14 and the vehicle electrics. A cooling system 18 includes a thermoelectric module assembly 20 supported on a cold plate assembly 22 that is in communication with a cooling loop 24. A cooling fluid, such as glycol, is circulated by a pump 31 within the cooling loop 24. Heat is rejected to the coolant via the cold plate assembly 22 through supply and return coolant lines 30, 32 that are connected to a heat exchanger 26. A fan or blower 28 may be used to remove heat from the coolant within the heat exchanger 26 to an ambient environment, for example.

A controller 34 communicates with various components of the vehicle 10, vehicle system 12 and cooling system 18 to coordinate battery cooling. Sensors and outputs (not shown) may be connected to the controller 34.

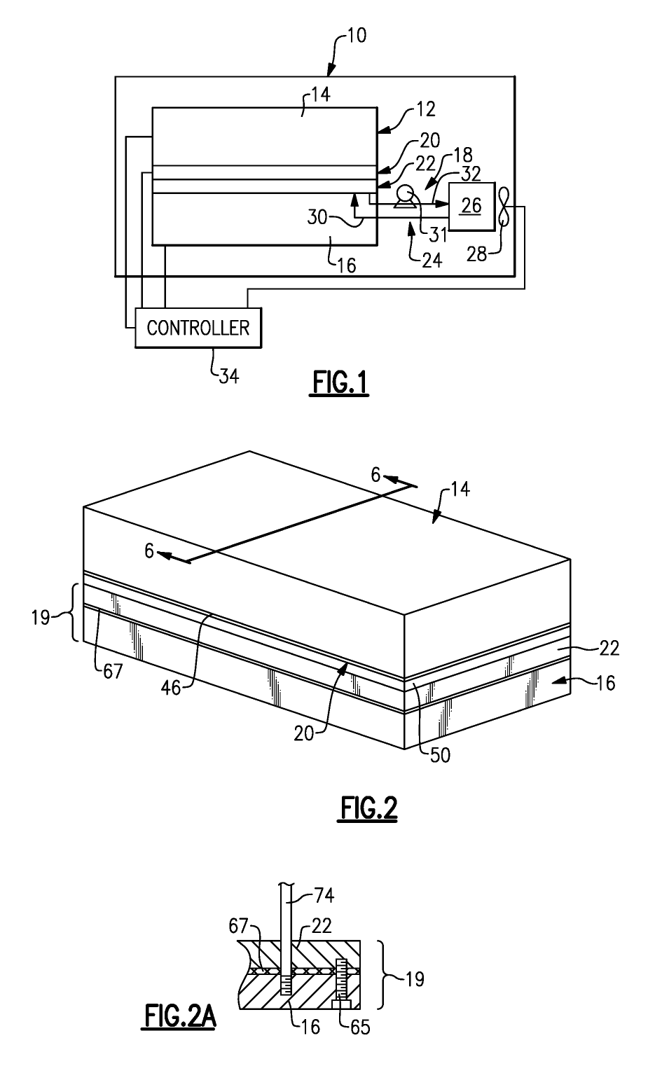

An example cooling system 18 includes a battery thermal management module shown in more detail in FIG. 2. Unlike the arrangement shown in FIG. 1, the stack in FIG. 2 includes a heat spreader 46 arranged between the thermoelectric module assembly 20 and the battery 14, although it should be understood that the heat spreader 46 may be omitted. The thermoelectric module assembly 20 includes a cold side that supports a surface of the battery 14 either directly or via the heat spreader 46.

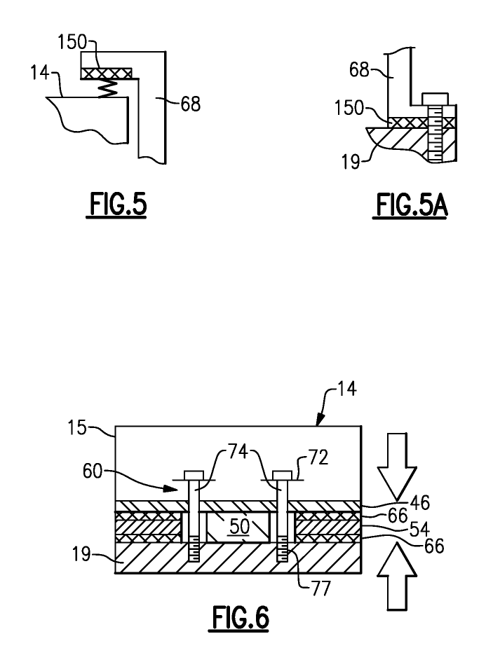

A thermal foil 67 may be arranged between and in engagement with the cold plate assembly 22 and the DC/DC converter 16, which are secured to one another using fasteners 65, as shown in FIG. 2A. The cold plate assembly 22 and DC/DC converter together comprise a clamping support 19 to which a clamping structure 60 (FIGS. 4 and 5) is secured. The clamping structure 60 applies a load to the battery 14 and the clamping support 19 to apply a clamping load (block arrows in FIGS. 4 and 5) to the thermoelectric module assembly 20.

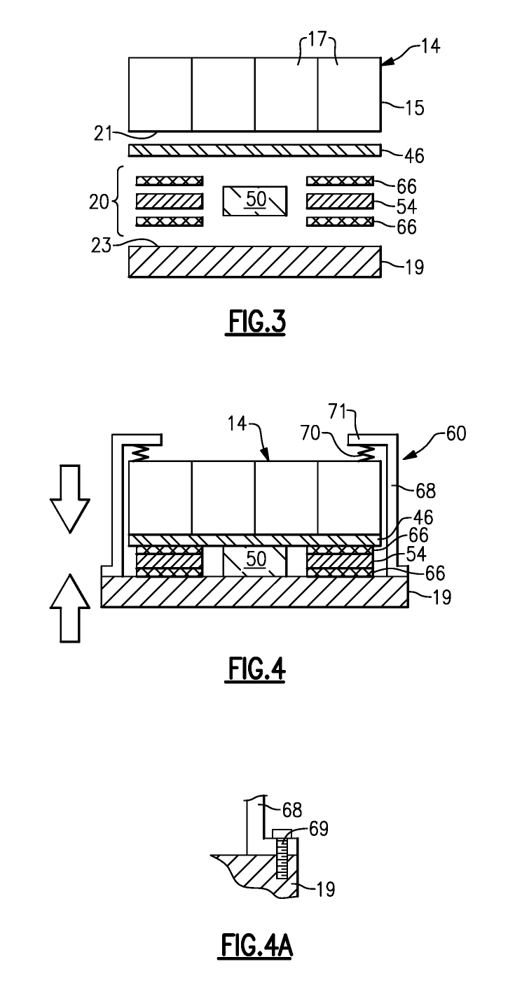

Turning to FIG. 3, an insulator plate 50 carries thermoelectric devices 54 and separates the cold side at the battery 14 from a hot side at the cold plate assembly 22. The insulator plate 50 is optional, but can be used to securely hold the thermoelectric devices 54 and its associated cable harness in place for assembly and in operation. The insulator plate 50 does not necessarily have physical contact to the cold plate assembly 22, heat spreader 46 or battery 14.

Referring to FIGS. 3-4A, an example thermoelectric module assembly 20 is shown in more detail. The battery 14 includes a housing 15 that encloses multiple cells 17, as shown in FIG. 3. In the example shown in FIG. 4A, the clamping structure 60 is provided by an enclosure 68 of the battery 14 secured to the clamping support 19 by fasteners 69 at one end. Another end of the enclosure 68 includes a flange 71 supporting a spring element 70 that applies a preload on the stack in a direction toward the cold plate assembly 22. Thus, the battery 14 is secured to the cold plate assembly 22 via the clamping load applied via the spring elements 70, which ensures desired engagement and heat transfer between the thermoelectric devices 54 and adjacent components (i.e., side 21 of battery 14 via heat spreader 46 and side 23 of cold plate assembly 22 in support structure 19). Moreover, the spring elements 70 limit the compressive forces within the stack throughout varying thermal conditions as the battery transitions between hot and cold conditions.

As shown in FIGS. 5-5A, a thermal insulator 150 may be provided between the enclosure 70 and the battery 14 and between the enclosure 70 and the clamping support 19. In this manner, the heat transfer between components within the system may be more predictable and, therefore, better controlled.

The cold side of the thermoelectric module assembly 20 is provided at the heat spreader 46, which is constructed from metal, for example. The heat spreader 46 is arranged on one side of the insulator plate 50, which is constructed from a plastic. The insulator plate 50 includes apertures within which thermoelectric devices 54 are arranged. In the example, the thermoelectric devices 54 utilize the Peltier effect to provide a cold side adjacent to the heat spreader 46 and a hot side operative adjacent to the cold plate assembly 22. A thermal foil 66 may be provided on each of the opposing surfaces of the thermoelectric device 54 to ensure adequate engagement between the heat transfer components for thermal efficiency. The thermal foils 66 may be omitted or replaced with thermal grease, solder or glue, if desired. In the example, a metallic bottom heat spreader is omitted opposite the heat spreader 46, which also may be omitted.

It is desirable to maintain a desired clamp load and engagement between the thermal transfer components of the thermoelectric module assembly 20 and the cold plate assembly 22. In the arrangement shown in FIG. 6, the battery 14 is clamped, screwed and/or joined (forces shown by block arrows) to the cold plate assembly 22 to maintain desired thermal engagement between the components in the stack. Such an arrangement provides few assembly steps, fewer parts, and eliminates a thermal bridge between the heat spreader 46 and the cooling plate 22 other than the thermoelectric devices 54.

In one example, fasteners 74 extend through holes in a portion 72 of the battery housing 15 and are received within insulated threaded holes 77 in the clamping support 19, such as the cold plate assembly 22 and/or DC/DC converter 16, to apply a clamping load on the thermoelectric devices 54. The fasteners 74 may be arranged at the perimeter of the stack and/or extend through the battery 14 and through the thermoelectric module assembly 20 near the thermoelectric devices 54. The fasteners 74 are tightened to a predetermined torque. One or more features may be incorporated to limit the travel of the battery 14 relative to the cold plate assembly 22 as the fasteners 74 are torqued. For example, the insulator plate 50 can be designed to be compliant, so that the clamping force mainly is directed towards the thermoelectric devices 54 and yet limits compression.

In another example, the battery 14 can be secured to the DC/DC converter 16 to provide the clamping load on the thermoelectric devices 54 in a stack (see FIG. 2, fasteners 74).

In operation, an undesired battery temperature is detected by the controller 34. The thermoelectric devices 54 are powered to produce a cold side of the thermoelectric device 54 that is transferred to the heat spreader 46 adjacent to the battery 14 increasing the temperature differential between these components and increasing the heat transfer therebetween. Heat from the battery 14 is transferred from the heat spreader 46 through the thermoelectric device 54 directly to the cold plate assembly 22 in the case of the example thermoelectric module assembly 20 shown in FIG. 5. However, the insulator plate 50 acts to prevent heat from being transmitted from the heat spreader 46 to the cold plate assembly 22. Coolant is circulated from the cold plate assembly 22 to the heat exchanger 26 (FIG. 1), which rejects heat to the ambient environment, and this heat transfer rate may be increased by use of the blower 28 (FIG. 1).

It should be understood that although a particular component arrangement is disclosed in the illustrated embodiment, other arrangements will benefit herefrom. Although particular step sequences are shown, described, and claimed, it also should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A cooling system for thermally conditioning a component, the cooling system comprising:
a battery providing a first side;
a cold plate assembly providing a second side;
a clamping support;
a thermoelectric device positioned between the first and second sides; and
a clamping structure secured to the clamping support and cooperating with the battery to generate a clamping load on the thermoelectric device through the battery and with the first and second sides.

2. The cooling system according to claim 1, wherein the clamping support includes the cold plate assembly and a DC/DC converter, the clamping structure secured to at least one of the cold plate assembly and the DC/DC converter.

3. The cooling system according to claim 2, wherein the DC/DC converter is mounted to the cold plate assembly.

4. The cooling system according to claim 3, comprising a thermal foil arranged between and in engagement with the cold plate assembly and the DC/DC converter.

5. The cooling system according to claim 2, wherein the clamping load provides thermal communication with the thermoelectric device and the DC/DC converter and the cold plate assembly.

6. The cooling system according to claim 5, comprising fasteners securing a housing of the DC/DC converter to the cold plate assembly.

7. The cooling system according to claim 2, wherein the clamping structure is secured to the clamping support by at least one fastener.

8. The cooling system according to claim 1, comprising a heat spreader arranged between the thermoelectric device and the battery.

9. The cooling system according to claim 8, comprising a thermal foil arranged between and engagement with the thermoelectric device and the heat spreader.

10. The cooling system according to claim 9, comprising a thermal foil arranged between and in engagement with the thermoelectric device and the cold plate assembly.

11. The cooling system according to claim 1, wherein the clamping load provides thermal communication with the thermoelectric device and the battery and the cold plate assembly.

12. The cooling system according to claim 11, wherein the battery includes a housing, comprising fasteners secured to a portion of the housing.

13. The cooling system according to claim 12, wherein the fasteners are threaded into the cold plate assembly.

14. The cooling system according to claim 12, comprising an insulator plate, wherein the thermoelectric device is arranged within the insulator plate that is positioned between the clamping support and the battery, the fasteners extend through the insulator plate.

15. The cooling system according to claim 1, wherein a thermal insulator is provided between the battery and the clamping structure and between the clamping structure and the clamping support.
